(19) United States
(12) Patent Application Publication
(10) Pub. No.: US 2009/0040538 A1
(43) Pub. Date: Feb. 12, 2009

(54) Image Processing Apparatus and Image Processing Method

(75) Inventor: Nobuhiro KARITO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/184,906

(22) Filed: Aug. 1, 2008

(30) Foreign Application Priority Data
Aug. 6, 2007 (JP) 2007-204624

(51) Int. Cl. G06K 15/10

(52) U.S. Cl. 358/1.8

(57) ABSTRACT

An image is classified into a letter/linework area, a specific image area, and a background area. An area that at least partially includes the letter/linework area but does not include the specific image area is set as a first area, while an area that at least partially includes the specific image area is set as a second area. In the first area, dots on each line are formed with one nozzle. In the second area, dots on each line are formed with at least two nozzles. This arrangement enables high-speed printing for images mainly consisting of letters and graphs, while enabling high-quality printing for images including photographs.

### BACKGROUND OF THE INVENTION

1. Field of the Invention

The present invention relates to an image printing-related technique.

2. Description of the Related Art

An inkjet printer alternately repeats a dot formation process of ejecting ink or another printing liquid from multiple nozzles moving in a preset scanning direction to form dots on printing paper and a feeding process of feeding the printing paper in a preset feeding direction. Arrangement of multiple dot arrays (raster lines) in the feeding direction gives a resulting printed image on the printing paper.

One printing technique adopted for the dot formation process and the feeding process is a pseudo band printing technique (one-pass printing) of forming each raster line by one pass. Another printing technique is an overlap printing technique (multi-pass printing) of forming each raster line by multiple passes. In the specification hereof the terminology ‘pass’ means an operation of ejecting ink from a moving nozzle to form dots (dot forming operation). The pass and an operation of feeding the printing paper in the feeding direction (feeding operation) are performed in an alternate manner. In the one-pass printing, each raster line is formed with only one nozzle. In-the multi-pass printing, each raster line is formed with multiple nozzles.

The pseudo band printing as the high-speed one-pass printing forms each raster line with only one nozzle. When the ejecting direction of the printing liquid from a nozzle is distorted by a production error or any other reason, the positions of all dots in a raster line formed with the nozzle are disturbed to cause banding in a resulting printed image. The overlap printing as the multi-pass printing forms each raster line with multiple nozzles. Even when the ejecting direction of the printing liquid from one of the multiple nozzles id distorted, the effect of distortion on a resulting formed raster line is rather restrictive. The overlap printing as the multi-pass printing is thus generally the higher-quality printing than the pseudo band printing but is the lower-speed printing than the pseudo band printing.

There is a known printing system adopting the above technique as disclosed, for example, in Japanese Patent Laid-Open No. H11-149360.

This prior art printing system distinguishes raster lines including color image data from raster lines including only monochromatic image data and adopts low-speed printing like multi-pass printing for the raster lines including the color image data while adopting high-speed printing like one-pass printing for the raster lines including only the monochromatic image data.

The relevant techniques are disclosed in, for example, Japanese Patent Laid-Open No. 2007-55202, No. 2003-145738, No. 2002-347230, No. H09-282472, and No. 2005-151064.

In office or company printing with a printer or a complex machine, images consisting of letters and graphs are often printed or photocopied with only black ink.

In the case of letters even slightly colored (for example, black letters having slightly colored edges as often arising in photocopies or colored letters), the prior art technique (disclosed in the above cited Japanese Patent Laid-Open No. H11-149360) adopts the low-speed printing for an image including such letters and graphs, regardless of the demand for the high-speed printing.

In an image including a monochromatic photograph, on the other hand, the prior art technique adopts the high-speed printing like one-pass printing even in the area of the monochromatic photograph. This undesirably makes banding rather conspicuous in a resulting printed image.

### SUMMARY OF THE INVENTION

There would thus be a demand for an image processing apparatus that enables high-speed printing for images mainly consisting of letters and graphs while enabling high-quality printing for images including photographs.

The present invention accomplishes at least part of the demands mentioned above and the other relevant demands by the following configurations applied to the image processing apparatus, the printing device, the image processing method, and the printing method.

According to one aspect, the present invention is directed to an image processing apparatus of generating print data to be provided to a printing device from image data representing an image. The printing device alternately repeats a dot formation process of ejecting a printing liquid from multiple nozzles onto a printing medium to form dots on a line along a preset first direction according to the print data and a feeding process of feeding the printing medium in a preset second direction perpendicular to the first direction. The printing device arranges multiple dot arrays in the second direction to print an image on the printing medium, where each of the multiple dot arrays consists of multiple dots aligned on a line along the first direction.

The image processing apparatus has an area classification module configured to classify the image into a background area representing a background, a letter/linework area including letters or linework, and a specific image area other than the background area and the letter/linework area with referring to constituent data of the image data. The area classification module sets an area of the image that at least partially includes the letter/linework area but does not include the specific image area as a first area, while setting an area of the image that at least partially includes the specific image area as a second area, based on a result of the classification. The image processing apparatus also has a command generation module configured to perform mapping of respective constituent data to the nozzles and setting of a feed amount of the printing medium to form dots on each line along the first direction in the first area with one nozzle and to perform mapping of respective constituent data to the nozzles and setting of the feed amount of the printing medium to form dots on each line along the first direction in the second area with at least two nozzles. The command generation module generates a print command reflecting a result of the mapping of the constituent data to the nozzles and the setting of the feed amount of the printing medium, and outputs data including the generated print command as the print data.

The image processing apparatus according to one aspect of the invention performs the mapping of the respective constituent data to the nozzles and the setting of the feed amount of the printing medium to form dots on each line with one nozzle in the first area that at least partially includes the letter/linework area but does not include the specific image area. The image processing apparatus performs the mapping of the respective constituent data to the nozzles and the setting of the feed amount of the printing medium to form dots on each line with at least two nozzles in the second area that at least partially includes the specific image area. The constituent data of the image data may be, for example, line data or pixel data. The specific image area includes, for example, a photograph.

The image processing apparatus according to the above aspect of the invention enables high-speed printing for areas including letters and line works, while enabling high-quality printing with prevention of banding for areas including photographs.

In one preferable application of the image processing apparatus according to the above aspect of the invention, the command generation module sets a mixed area on a boundary between the first area and the second area and performs mapping of respective constituent data to the nozzles and setting of the feed amount of the printing medium to allow coexistence of lines of dot formation with only one dot and lines of dot formation with at least two nozzles in the mixed area.

The presence of the mixed area preferably makes a difference in picture quality between the first area and the second area inconspicuous in a resulting printed image.

In another preferable application of the image processing apparatus according to the above aspect of the invention, the area classification module classifies the image in the unit of a line along the first direction and sets each line as the first area on condition that pixels in the line include at least pixels in the letter/linework area but do not include pixels in the specific image area, while setting each line as the second area on condition that pixels in the line include at least pixels in the specific image area.

In the image processing apparatus of this application, there is a boundary in the unit of a line between the first area and the second area. This arrangement desirably facilitates the mapping of the respective constituent data to the nozzles and the setting of the feed amount of the printing medium.

In the image processing apparatus of the invention, the area classification module may set the letter/linework area as the first area and the specific image area as the second area.

The image processing apparatus of this application forms dots on each line with one nozzle in all letter/linework areas included in a print object image as a target of printing, thus enabling higher-speed printing.

According to another aspect, the present invention is directed to a printing device configured to alternately repeat a dot formation process of ejecting a printing liquid from multiple nozzles onto a printing medium to form dots on a line along a preset first direction and a feeding process of feeding the printing medium in a preset second direction perpendicular to the first direction. The printing device arranges multiple dot arrays in the second direction to print an image on the printing medium, where each of the multiple dot arrays consists of multiple dots aligned on a line along the first direction. The image is classified into a background area representing a background, a letter/linework area including letters or linework, and a specific image area other than the background area and the letter/linework area. In a first area of the image that at least partially includes the letter/linework image but does not include the specific image area, the dot formation process and the feeding process are performed to form dots on each line along the first direction with one nozzle. In a second area of the image that at least partially includes the specific image area, the dot formation process and the feeding process are performed to form dots on each line along the first direction with at least two nozzles.

The printing device according to this aspect of the invention enables high-speed printing for areas of an image including letters and line works, while enabling high-quality printing with prevention of banding for areas of the image including photographs.

According to still another aspect, the invention is directed to a printing device of ejecting a printing liquid from multiple nozzles onto a printing medium to form dots on lines along a preset direction and thereby print an image. The image is classified into a background area representing a background, a letter/linework area including letters or linework, and a specific image area other than the background area and the letter/linework area. In printing a first area of the image that at least partially includes the letter/linework image but does not include the specific image area, the printing device forming dots on each line with one nozzle. In printing a second area of the image that at least partially includes the specific image area, the printing device forming dots on each line with at least two nozzles.

The printing device according to this aspect of the invention also enables high-speed printing for areas of an image including letters and line works, while enabling high-quality printing with prevention of banding for areas of the image including photographs.

Another aspect of the invention is an image processing method of generating print data to be provided to a printing device from image data representing an image. The printing device alternately repeats a dot formation process of ejecting a printing liquid from multiple nozzles onto a printing medium to form dots on a line along a preset first direction according to the print data and a feeding process of feeding the printing medium in a preset second direction perpendicular to the first direction. The printing device arranges multiple dot arrays in the second direction to print an image on the printing medium, where each of the multiple dot arrays consists of multiple dots aligned on a line along the first direction.

The image processing method classifies the image into a background area representing a background, a letter/linework area including letters or linework, and a specific image area other than the background area and the letter/linework area with referring to constituent data of the image data. The image processing method sets an area of the image that at least partially includes the letter/linework area but does not include the specific image area as a first area while setting an area of the image that at least partially includes the specific image area as a second area, based on a result of the classification The image processing method performs mapping of respective constituent data to the nozzles and setting of a feed amount of the printing medium to form dots on each line along the first direction in the first area with one nozzle, while performing mapping of respective constituent data to the nozzles and setting of the feed amount of the printing medium to form dots on each line along the first direction in the second area with at least two nozzles. The image processing method generates a print command reflecting a result of the mapping of the constituent data to the nozzles and the setting of the feed amount of the printing medium, and outputs data including the generated print command as the print data.

The image processing method according to this aspect of the invention has the same effects and advantages to those of the image processing apparatus described above.

Still another aspect of the invention is a printing method of ejecting a printing liquid from multiple nozzles onto a printing medium to form dots on lines along a preset direction and thereby print an image.

The printing method classifies the image into a background area representing a background, a letter/linework area including letters or linework, and a specific image area other than the background area and the letter/linework area. In printing a first area of the image that at least partially includes the letter/linework image but does not include the specific image area, the printing method forms dots on each line with one nozzle. In printing a second area of the image that at least partially includes the specific image area, the printing method forms dots on each line with at least two nozzles.

The printing method according to this aspect of the invention has the same effects and advantages to those of the printing device described above.

Another aspect of the invention is a computer program executed to generate print data to be provided to a printing device from image data representing an image. The printing device alternately repeats a dot formation process of ejecting a printing liquid from multiple nozzles onto a printing medium to form dots on a line along a preset first direction according to the print data and a feeding process of feeding the printing medium in a preset second direction perpendicular to the first direction. The printing device arranges multiple dot arrays in the second direction to print an image on the printing medium, where each of the multiple dot arrays consists of multiple dots aligned on a line along the first direction.

The computer program includes multiple functions to be actualized by a computer. The first function classifies the image into a background area representing a background, a letter/linework area including letters or linework, and a specific image area other than the background area and the letter/linework area with referring to constituent data of the image data, and sets an area of the image that at least partially includes the letter/linework area but does not include the specific image area as a first area while setting an area of the image that at least partially includes the specific image area as a second area, based on a result of the classification. The second function performs mapping of respective constituent data to the nozzles and setting of a feed amount of the printing medium to form dots on each line along the first direction in the first area with one nozzle. The third function performs mapping of respective constituent data to the nozzles and setting of the feed amount of the printing medium to form dots on each line along the first direction in the second area with at least two nozzles. The fourth function generates a print command reflecting a result of the mapping of the constituent data to the nozzles and the setting of the feed amount of the printing medium, and outputs data including the generated print command as the print data.

The computer program according to this aspect of the invention has the same effects and advantages to those of the image processing apparatus described above.

The present invention is not restricted to the image processing apparatus, the printing device, the image processing method, the printing method, or the computer program executed to actualize any of the image processing apparatus, the printing device, and the corresponding methods. The present invention may be actualized by diversity of other applications, for example, recording media in which such computer programs are recorded and data signals configured to include such computer programs and embodied in carrier waves.

### BRIEF DESCRIPTION OF THE DRAWINGS

FIG. 1 is a block diagram illustrating the configuration of a printing system including an image processing apparatus in one embodiment of the invention;

FIG. 2 is a flowchart showing a processing routine of image processing and printing image data in the printing system of FIG. 1;

FIG. 3 is a flowchart showing an area classification process performed by an area classification module in the image processing apparatus of FIG. 1;

FIG. 4 shows one example of a print object image as a target of printing;

FIG. 5 is a flowchart showing a rasterizing process performed by a rasterizing process module in the image processing apparatus of FIG. 1;

FIG. 6 shows a positional relationship between nozzles on a head and areas on printing paper;

FIG. 7 shows a concrete example of data mapping to nozzles and settings of a paper feed amount by the rasterizing process of FIG. 5;

FIG. 8 shows a print object image as a target of printing and a head scan trajectory in printing according to a procedure of Modified Example 3; and

FIG. 9 shows a concrete example of data mapping to the nozzles and settings of the paper feed amount in Modified Example 3.

### DESCRIPTION OF THE PREFERRED EMBODIMENTS

Some modes of carrying out the invention are described below in the following sequence with reference to the accompanied drawings:

### A. System Configuration of Embodiment

### B. Operations of Embodiment

B-1. Outline of Image Processing and Printing Process

B-2. Area Classification Process

B-3. Rasterizing Process

### C. Effects of Embodiment

### D. Other Aspects

### A. System Configuration of Embodiment

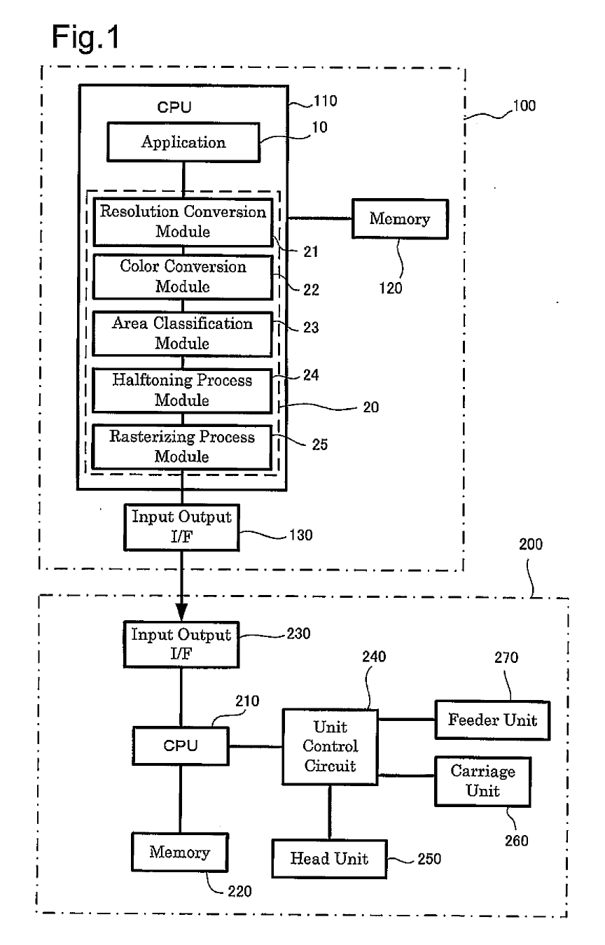

FIG. 1 is a block diagram illustrating the configuration of a printing system including an image processing apparatus in one embodiment of the invention. The printing system of FIG. 1 includes an image processing apparatus 100 and a printing device 200 having wired (for example, cable) or wireless connection with the image processing apparatus 100. The image processing apparatus 100 is constructed by a personal computer and mainly includes a CPU 110 configured to perform diversity of processes and controls according to programs, a memory 120 configured to store programs as well as data and information, and an input output interface (I/F) 130 configured to transmit data and information to and from externally connected peripheral devices. In addition to these primary components, the image processing apparatus 100 also has non-illustrated peripheral devices including an input device like a keyboard and a pointing device, a display device like a display, and a record reproduction device like a CD-ROM drive.

Various programs including an application 10 and a printer driver 20 are installed in the image processing apparatus 100. The printer driver 20 functions to generate print data from image data output from the application 10. The printer driver 20 may be distributed in storage of a CD-ROM or any other suitable recording medium (computer readable recording medium) or may be delivered via the Internet or by any other suitable communication means.

The CPU 110 of the image processing apparatus 100 executes the programs including the application 10 and the printer driver 20 under an operating system (not shown) installed in the computer. The application 10 has, for example, image editing functions to generate image data and make the generated image data subject to a user's desired series of image processing. The user operates a user interface of the application 10 to give an instruction of printing an image edited according to the application 10. In response to the user's printing instruction, the application 10 outputs image data to the printer driver 20.

The printer driver 20 inputs the image data from the application 10, generates print data from the input image data, and outputs the generated print data to the printing device 200. The print data represents data in a specific format interpretable by the printing device 200 and includes various command data and pixel data. The command data represents print commands for instructing the printing device 200 to perform specific operations. The pixel data represents data on pixels constituting an object image to be printed (print image). One typical example of the pixel data is data regarding dots to be formed at specific locations on a printing medium corresponding to respective pixels (for example, data regarding the colors and sizes of dots).

In order to actualize the function of generating print data from image data output from the application 10, the printer driver 20 includes a resolution conversion module 21, a color conversion module 22, an area classification module 23, a halftoning process module 24, and a rasterizing process module 25.

The resolution conversion module 21 performs a resolution conversion process to convert image data (for example, text data or pictorial data) output from the application 10 into data in a printing resolution on a printing medium. The color conversion module 22 performs a color conversion process to convert RGB data into multi-tone CMYK data expressed in a CMYK color space. The area classification module 23 classifies an image into predetermined areas according to image data and sets areas of different printing methods in the image based on the classification result as described later. The halftoning process module 24 performs a halftoning process to convert data expressed in a large number of tones into data in a smaller number of tones expressible by the printing device 200. The rasterizing process module 25 performs a process of rearranging image data in a matrix to data in an order of transfer to the printing device 200, as well as a process of mapping data to nozzles and setting a paper feed amount as described later.

The area classification module 23 and the rasterizing process module 25 of the embodiment are respectively equivalent to the area classification module and the command generation module of the invention.

The printing device 200 is an inkjet printer and mainly includes a CPU 210 configured to control the whole printing device 200 and perform various processes and operations according to programs, a memory 220 configured to store programs as well as data and information, an input output interface (I/F) 230 configured to transmit data and information to and from the externally connected image processing apparatus 100, a unit control circuit 240 configured to control respective units in response to commands from the CPU 210, a head unit 250, a carriage unit 260, and a feeder unit 270.

The head unit 250 has a head (not shown) structured to eject ink or another printing liquid on a printing medium. The head has multiple nozzles, from which ink or another printing liquid is ejected in an intermittent manner. The head is mounted on a carriage (not shown) and moves in a preset scanning direction simultaneously with the carriage moving in the preset scanning direction. Intermittent ejection of ink during a motion of the head in the preset scanning direction causes dot lines (raster lines) along the preset scanning direction to be formed on the printing medium.

The carriage unit 260 is a drive unit configured to move the carriage with the head mounted thereon back and force in the preset scanning direction. An ink cartridge for keeping the ink therein is also detachably attached to the carriage.

The feeder unit 270 is a drive unit configured to set a printing medium at a printable position and feed the printing medium by a specified feed amount in a preset feeding direction (for example, in a direction perpendicular to the scanning direction of the carriage) in the course of printing. The feeder unit 270 is constructed by, for example, a paper feed roller, a feed motor, a conveyor roller, a platen, and a paper discharge roller (not shown).

### B. Operations of Embodiment

B-1. Outline of Image Processing and Printing Process

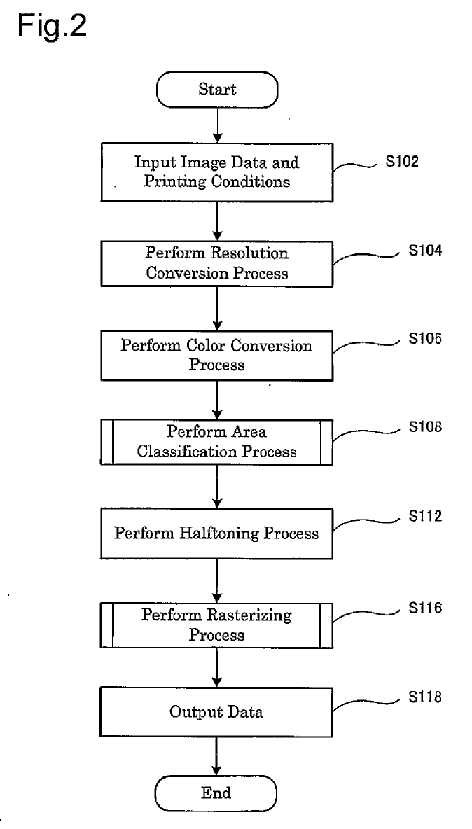

FIG. 2 is a flowchart showing a processing routine of image processing and printing image data in the printing system of FIG. 1. When the user enters a desired image to be printed (image data) and printing conditions including a printing resolution and a paper size on the application 10 (step S102) and gives a printing instruction, a print command is sent from the application 10 to the printer driver 20. The print command includes image data edited on the application 10.

The resolution conversion module 21 of the printer driver 20 converts image data in a certain resolution (for example, 360 dpi) included in the print command into data in a printing resolution of an integral multiple (for example, 720 dpi) corresponding to a nozzle density on the head and a picture quality (step S104). The color conversion module 22 converts the resolution-converted RGB image data into CMYK data corresponding to color inks (for example, cyan, magenta, yellow, black, light cyan, and light magenta) used in the printing device 200 (step S106). The resulting CMYK data obtained by such color conversion is 256-tone CMYK image data.

The area classification module 23 refers to the CMYK image data and classifies the image into areas of background attribute or areas expressing background (hereafter may be referred to as background areas), areas of letter/linework attribute or areas including letters and line works (hereafter may be referred to as letter/linework areas), and areas of third attribute other than the background attribute and the letter/linework attribute, for example, areas including photographs (hereafter may be referred to as specific image areas). In general, the background area represents an area expressing background without letters or any other print object elements. The letter/linework area represents an area including a letter or a line work. The specific image area represents an area including, for example, a photograph. The area classification module 23 sets high-speed printing areas, standard printing areas, and print skip areas in the image, based on the classification result (step S108). The area classification process performed by the area classification module 23 will be described later in detail.

The halftoning process module 24 converts the 256-tone image data into multivalue data (for example, multivalue data in 4 tones) corresponding to ink density dot sizes with regard to each color ink (step S112).

The rasterizing process module 25 performs the rasterizing process to rearrange the multivalue image data into data in an order of transfer to the printing device 200 (step S116) and outputs the rearranged data by the rasterizing process as print data to the printing device 200 (step S118). The rasterizing process of step S116 performs data mapping to the nozzles on the head and sets a paper feed amount to enable a high-speed print mode of creating dots on one raster line with only one nozzle in the high-speed printing area set by the area classification process of step S108. The rasterizing process performs data mapping to the nozzles on the head and sets a paper feed amount to enable a standard print mode of creating dots on one raster line with two or more nozzles in the standard printing area set by the area classification process. The rasterizing process then generates a print command corresponding to the data mapping and the set paper feed amount and adds command data representing the generated print command to the print data. The rasterizing process performed by the rasterizing process module 25 will be described later in detail.

In response to input of print data from the image processing apparatus 100, the printing device 200 performs a printing operation. The CPU 210 receives a print command and print data from the image processing apparatus 100 via the input output interface 230 and analyzes various commands included in the received print data.

The CPU 210 first controls the feeder unit 270 via the unit control circuit 240, based on the result of the analysis. The feeder unit 270 is controlled to feed printing paper (printing medium) into the printing device 200 and position the printing paper at a print start position. At least part of the nozzles on the head is located to face the printing paper positioned at the print start position.

The CPU 210 subsequently controls the carriage unit 260 via the unit control circuit 240. The carriage unit 260 is controlled to move the carriage with the head mounted thereon in the preset scanning direction. The CPU 210 controls the head unit 250 via the unit control circuit 240, based on the result of the analysis. The head unit 250 is controlled to intermittently eject ink or another printing liquid from the respective nozzles on the head moving in the preset scanning direction according to the print data and creates dots on the printing paper. The CPU 210 again controls the feeder unit 270 via the unit control circuit 240, based on the paper feed amount specified by the result of the analysis. The feeder unit 270 is controlled to feed the printing paper in the feeding direction by the specified paper feed amount and thereby move the printing paper relative to the head. This enables the head to create dots at different positions from the positions of previously created dots.

Until all the print data is processed, the above series of processing for dot creation and paper feeding is repeated to print an image consisting of dots on the printing paper. The printing operation is terminated on completion of processing with regard to all the print data.

B-2. Area Classification Process

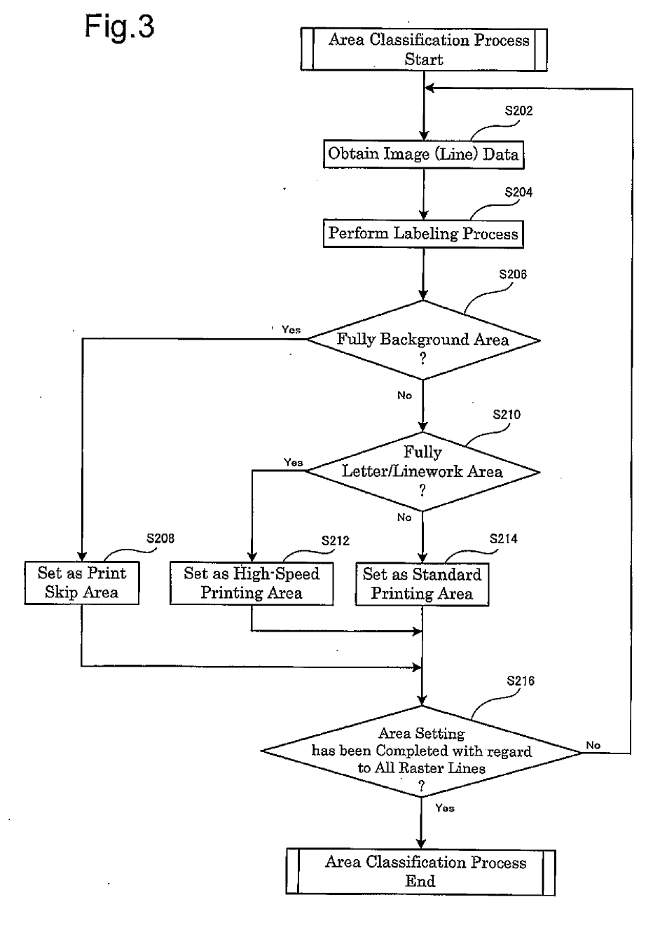

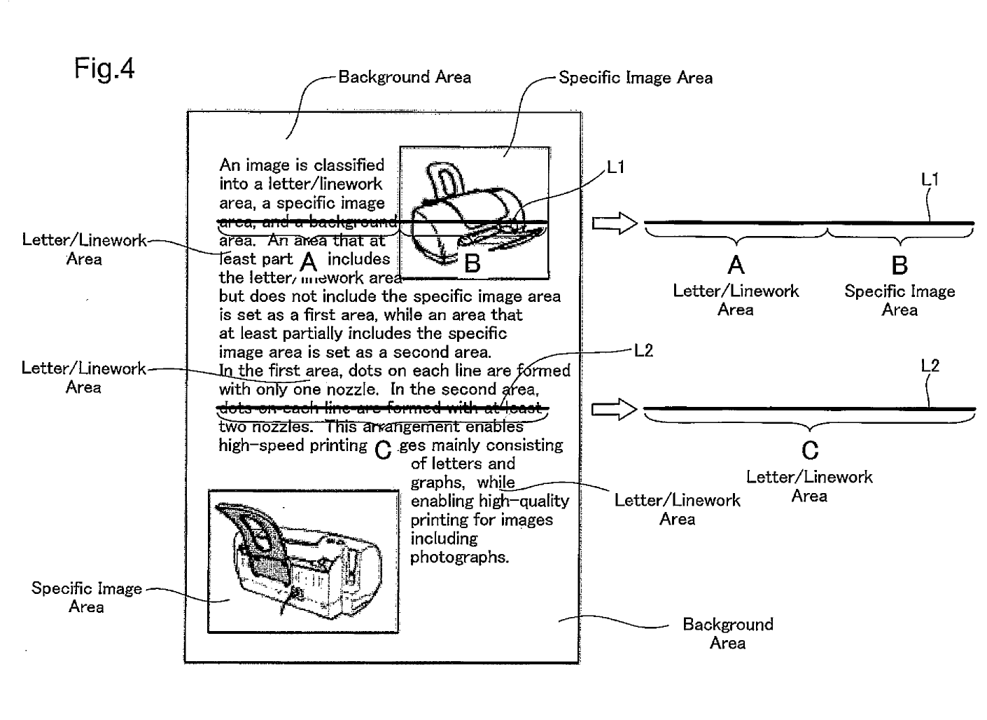

The details of the area classification process are explained. FIG. 3 is a flowchart showing the details of the area classification process performed by the area classification module 23 in the image processing apparatus 100 of FIG. 1. FIG. 4 shows one example of a print object image as a target of printing.

In the area classification process of FIG. 3, the area classification module 23 first obtains the image data (CMYK data) after the color conversion by the color conversion module 22 in the unit of a raster line as line data (step S202).

The area classification module 23 subsequently performs a labeling process to identify the attribute of each pixel included in the raster line corresponding to the obtained line data among the three attributes, the background attribute, the letter/linework attribute, and the third attribute (for example, photograph) other than the background attribute and the letter/linework attribute (step S204). The raster line corresponding to the obtained line data is called a target line.

The labeling process sequentially sets a pixel included in the target line as a target pixel, for example, from the left end of the raster line and determines whether a data value of the target pixel satisfies Condition 1 given below. The image data has 256 tone values as mentioned previously.

Condition 1: Luminance of Pixel=255 ((R,G,B)=(255,255,255))

Upon satisfaction of Condition 1, the target pixel is determined to have the background attribute and is identified to be in a background area.

Upon failure of Condition 1, the labeling process determines whether the data value of the target pixel satisfies Condition 2 given below.

Condition 2: Luminance of Pixel<160 or Saturation of Pixel<15

Upon satisfaction of Condition 2, the target pixel is determined to have the letter/linework attribute and is identified to be in a letter/linework area.

Upon failure of Condition 2, the target pixel is determined to have the third attribute other than the background attribute and the letter/linework attribute and is identified to be in a specific image area.

In this manner, the area classification module 23 sequentially sets the target pixel in the target line and performs the labeling process with regard to all the pixels included in the target line to classify the target line into the background area, the letter/linework area, and the specific image area.

The print object image as the target of printing shown in FIG. 4 has an image portion filled with letters and two image portions with insertion of photographs. The image portion filled with letters is a letter/linework areas and the image portions with insertion of photographs are specific image areas. The remaining blank portion is a background area.

A raster line L1 in the print object image is set to the target line as the object of the labeling process. Pixels included in a part A of the target line L1 do not satisfy Condition 1 but satisfy Condition 2 and are accordingly identified to be in a letter/linework area. Pixels included in a part B of the target line L2 satisfy neither Condition 1 nor Condition 2 and are accordingly identified to be in a specific image area. Namely the labeling process classifies the target line L1 into a letter/linework area and a specific image area.

A raster line L2 in the print object image is set to the target line as the object of the labeling process. Pixels included in a part C of the target line L2 (that is, all pixels included in the target line L2) do not satisfy Condition 1 but satisfy Condition 2 and are accordingly identified to be in a letter/linework area. Namely the labeling process classifies the target line L2 fully into a letter/linework area.

On completion of the labeling process with regard to all the pixels included in the target line, the area classification module 23 performs an area setting process to set the target line as one of a print skip area, a high-speed printing area, and a standard printing area.

According to the concrete procedure, the area classification module 23 refers to the result of the labeling process (the result of area classification) with regard to the target line and determines whether all the pixels included in the target line are fully identified to be in a background area (step S206). When all the pixels in the target line are identified to be in a background area, there is no need of printing the target line. The target line is accordingly set as a print skip area (step S208).

When at least part of the pixels in the target line is identified to be not in a background area, the area classification module 23 determines whether all the pixels in the target line excluding the pixels in the background area are fully identified to be in a letter/linework area (step

When all the pixels in the target line excluding the pixels in the background area are identified to be in a letter/linework area, the target line is set as a high-speed printing area (step S212). When at least part of the pixels in the target line excluding the pixels in the background area is identified to be not in a letter/linework area but in a specific image area, the target line is set as a standard printing area (step S214).

In the illustrated example of FIG. 4, the target line L1 is classified into a letter/linework area and a specific image area. Namely at least part of the pixels in the target line L1 are identified to be not in a letter/linework area but in a specific image area. The target line L1 is accordingly set as a standard printing area. The target line L2 is classified fully into a letter/linework area. Namely all the pixels in the target line L2 are identified to be in a letter/linework area. The target line L2 is accordingly set as a high-speed printing area.

On completion of the area setting process with regard to the target line, the area classification module 23 determines whether the area setting has been completed with regard to all raster lines included in the print object image specified as the target of printing (step S216). When there is any unprocessed raster line, the area classification module 23 obtains line data of a next target line (step S202) and repeats the above series of processing. After obtaining line data of all the raster lines included in the print object image and performing the area setting process with regard to all the raster lines, the area classification module 23 terminates the area classification process of FIG. 3.

B-3. Rasterizing Process

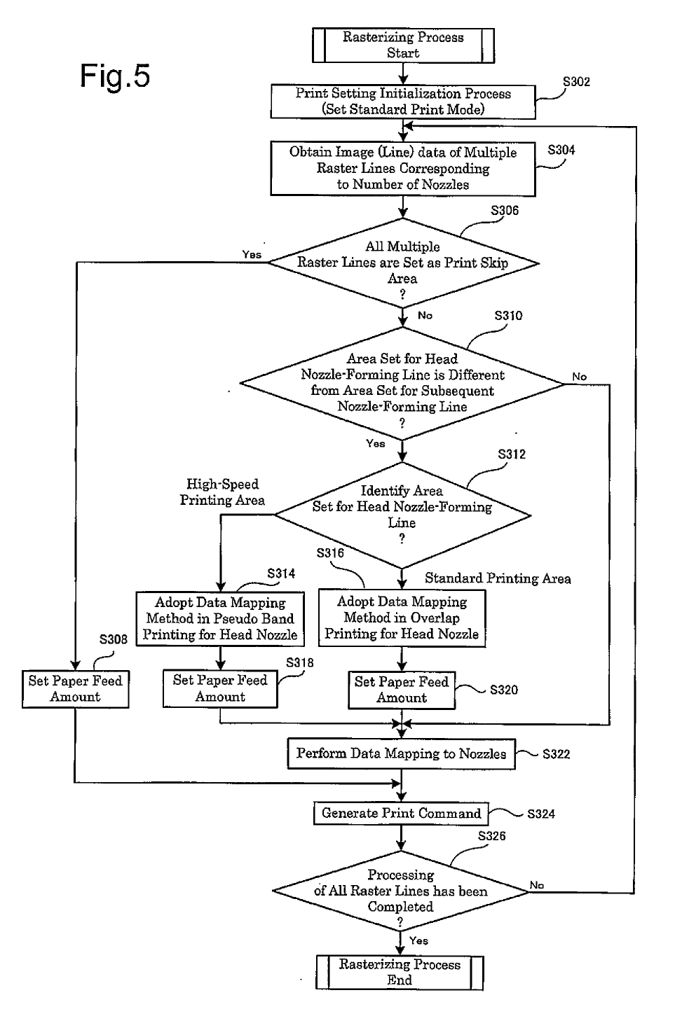

The details of the rasterizing process are explained. FIG. 5 is a flowchart showing the details of the rasterizing process performed by the rasterizing process module 25 in the image processing apparatus 100 of FIG. 1. As explained previously, in the printing device 200, ejection of ink or another printing liquid from multiple nozzles on the head moving in the preset scanning direction forms multiple raster lines along the scanning direction on the printing medium. The rasterizing process controls the print mode in each scan of the head (each motion of the head in the preset scanning direction) among a print skip mode, a high-speed print mode (pseudo band printing), and a standard print mode (overlap printing).

In the rasterizing process of FIG. 5, the rasterizing process module 25 performs a print setting initialization process to set the initial state to the standard print mode (step S302). The rasterizing process module 25 subsequently obtains line data of multiple raster lines corresponding to the number of nozzles on the head from the multivalue image data after the tone conversion by the halftoning process module 24 (step S304). One scan of the head simultaneously forms multiple raster lines corresponding to the number of nozzles. The line data of the corresponding number of multiple raster lines is accordingly required for the rasterizing process.

The rasterizing process module 25 determines whether all the multiple raster lines of the obtained raster data are set as the print skip area (step S306). When all the multiple raster lines are set as the print skip area, there is no need of printing the multiple raster lines. The rasterizing process module 25 accordingly sets only a paper feed amount for feeding the printing paper in the printing device 200 (step S308) and generates a print command representing the set paper feed amount (step S324). The rasterizing process module 25 goes back the processing flow to step S304 to obtain and process line data of multiple raster lines for a next scan of the head.

When it is determined at step S306 that at least part of the raster lines is set not as the print skip area but either as the letter/linework area or as the specific image area, the rasterizing process module 25 compares a raster line of dot formation by a head nozzle (hereafter referred to as head nozzle-forming line) with a raster line of dot formation by a subsequent nozzle (hereafter referred to as subsequent nozzle-forming line) and determines whether the area set for the head nozzle-forming line is different from the area set for the subsequent nozzle-forming line (step S310). For example, when the area set for the head nozzle-forming line is a high-speed printing area and the area set for the subsequent nozzle-forming line is a standard printing area, these areas are determined to be different. In another example, when both the area set for the head nozzle-forming line and the area set for the subsequent nozzle-forming line are standard printing areas, these areas are determined to be identical.

Such determination is explained concretely with referring to a positional relation between nozzles on a head and areas on printing paper.

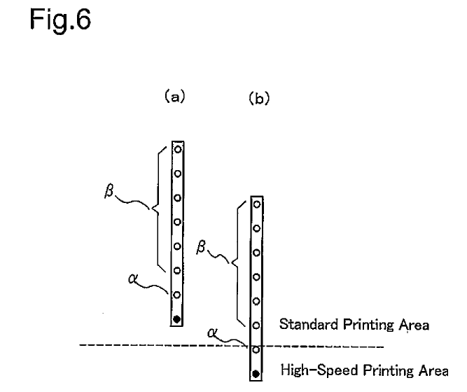

FIG. 6 shows the positional relationship between the nozzles on the head and the areas on the printing paper. For convenience of explanation, FIG. 6 shows only one nozzle array among multiple nozzle arrays arranged on the bottom face of the head (not shown). The number of nozzles included in the nozzle array is also reduced to eight. Open circles represent nozzles involved in ink ejection, and closed circles represent nozzles not involved in ink ejection. The head (nozzle array) is illustrated to move downward relative to the printing paper in FIG. 6. This drawing, however, simply shows the relative position of the head to the printing paper. In the actual printing operation, the printing paper is fed in the feeding direction.

The relative moving direction of the head is set to the downward direction in the illustration of FIG. 6. Among the nozzles involved in ink ejection, a nozzle α is the head nozzle, and nozzles β following the head nozzle α are the subsequent nozzles.

In the state of FIG. 6(b) where the head nozzle α is located in a high-speed printing area and the subsequent nozzle β is located in a standard printing area, it is determined that the area set for the head nozzle-forming line and the area set for the subsequent nozzle-forming line are different. In the state of FIG. 6(a) where both the head nozzle α and the subsequent nozzle β are located in a standard printing area, it is determined that the area set for the head nozzle-forming line and the area set for the subsequent nozzle-forming line are identical.

When the area set for the head nozzle-forming line and the area set for the subsequent nozzle-forming line are determined to be different, the rasterizing process module 25 identifies whether the area set for the head nozzle-forming line is a standard printing area or a high-speed printing area (step S312). The rasterizing process module 25 selectively adopts the method of data mapping for the head nozzle α according to the result of the identification (step S314 or step S316) and changes the paper feed amount in response to a switchover between the standard print mode and the high-speed print mode (step S318 or step S320).

When the area set for the head nozzle-forming line is identified as a high-speed printing area (that is, when the head nozzle α shifts from a standard printing area to a high-speed printing area), the paper feed amount is set to a value corresponding to seven nozzles (for example, a length of seven pixel pitches in print data) (step S318). When the area set for the head nozzle-forming line is identified as a standard printing area (that is, when the head nozzle α shifts from a high-speed printing area to a standard printing area), on the other hand, the paper feed amount is set to a value corresponding to three nozzles (for example, a length of three pixel pitches in print data) (step S320).

The rasterizing process module 25 identifies each raster line as a line of dot formation with only one nozzle or as a line of dot formation with multiple nozzles and maps line data of respective raster lines to the nozzles on the head (step S322).

In the high-speed printing area, the high-speed print mode (pseudo band printing) is generally adopted to set one-to-one mapping of each line data to one nozzle. In the standard printing area, the standard print mode (overlap printing) is generally adopted to set one-to-multiple mapping of each line data to two or more nozzles. When the area set for the head nozzle-forming line is identified as a high-speed printing area, the data mapping method in pseudo band printing is adopted for the head nozzle α at step S314. When the area set for the head nozzle-forming line is identified as a standard printing area, the data mapping method in overlap printing is adopted for the head nozzle α at step S316.

The rasterizing process module 25 sets a mixed printing area on a boundary between the standard printing area and the high-speed printing area (that is, an area of switchover from one printing area to another printing area). In the mixed printing area, the rasterizing process module 25 maps line data of respective raster lines to the nozzles on the head and adjusts the paper feed amount to allow the coexistence of raster lines of dot formation with only one nozzle and raster lines of dot formation with two or more nozzles.

The rasterizing process module 25 then generates a print command corresponding to the set paper feed amount and the data mapping (step S324). On completion of the processing with regard to the obtained line data of the multiple raster lines for one scan of the head, it is determined whether all raster lines included in the print object image have been processed (step S326). When there are any unprocessed raster lines, the rasterizing process module 25 goes back the processing flow to step S304 to obtain and process line data of multiple raster lines for a next scan of the head. The rasterizing process of FIG. 5 is terminated on completion of processing with regard to all the raster lines.

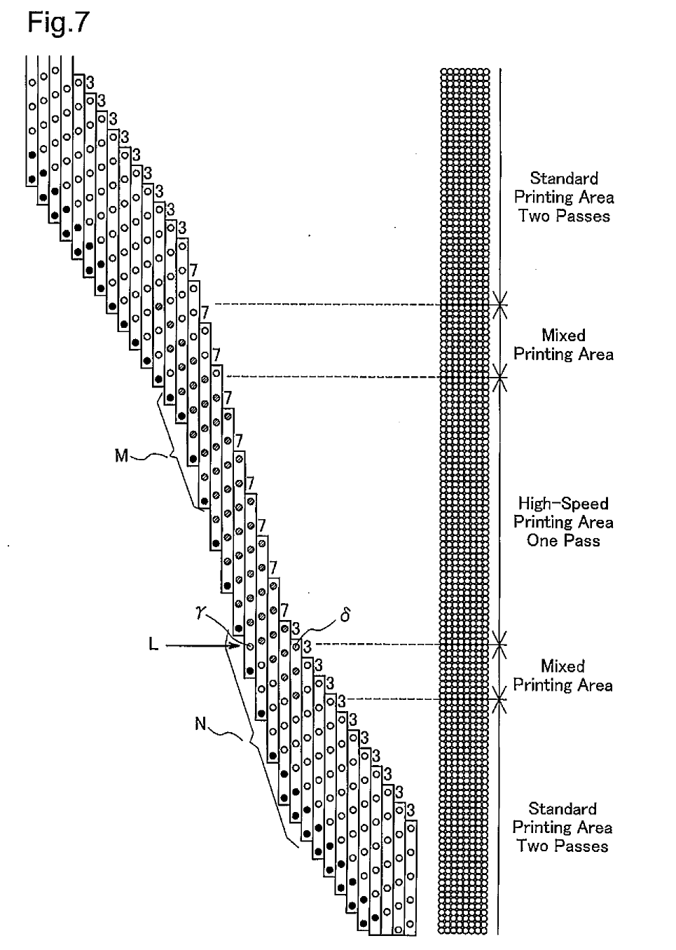

The data mapping to the nozzles and the settings of the paper feed amount by the rasterizing process are explained with reference to a concrete example. FIG. 7 shows a concrete example of data mapping to nozzles and settings of the paper feed amount by the rasterizing process of FIG. 5. In the illustration of FIG. 7, the lateral direction is a head scanning direction, and the vertical direction is a paper feed direction.

The illustrated example of FIG. 7 sequentially prints a standard printing area in the standard print mode (overlap printing: two passes), a high-speed printing area in the high-speed print mode (pseudo band printing: one pass), and a standard printing area in the standard print mode.

In FIG. 7, open circles and hatched circles represent nozzles involved in ink ejection. Each open circle represents a nozzle working in combination with another nozzle to form one raster line, whereas each hatched circle represents a nozzle working alone to form one raster line. Closed circles represent nozzles not involved in ink ejection. Each figure shown on the right side of the nozzle array represents a paper feed amount in each scan. The unit of the paper feed amount is pixel pitch in print data. Small open dots shown on the right side of the nozzle array represent dots formed by respective nozzles. For convenience of explanation, each nozzle forms only several dots in the illustrated example of FIG. 7. In the actual printing operation, however, intermittent ejection of ink or another printing liquid from each nozzle moving in the scanning direction of the head (equivalent to the lateral direction of FIG. 7) forms a large number of dots arrayed in the scanning direction.

The procedure of this embodiment varies the switchover timing of the paper feed amount according to the type of the area where the head nozzle enters. In a shift of the head nozzle from the standard printing area to the high-speed printing area, that is, in a shift from the standard print mode (overlap printing: two passes) to the high-speed print mode (pseudo band printing: one pass), the paper feed amount is changed from ‘3’ to ‘7’ immediately when the head nozzle enters the high-speed printing area from the previous different area as shown by a portion M in FIG. 7.

In a shift of the head nozzle from the high-speed printing area to the standard printing area, that is, in a shift from the high-speed print mode (pseudo band printing: one pass) to the standard print mode (overlap printing: two passes), on the other hand, the paper feed amount is changed from ‘7’ to ‘3’ after elapse of one overlap cycle when the head nozzle goes out of the high-speed printing area to enter the subsequent different area as shown by a portion N in FIG. 7. Overlap printing is adopted for a raster line at the location shown by a solid arrow in the portion N. The paper feed amount is changed from ‘7’ to ‘3’ to align the position of a head nozzle 7 and the position of a subsequent nozzle 8 on the raster line.

### C. Effects of Embodiment

As described above, when all pixels in one raster line excluding pixels in a background area are identified to be in a letter/linework area, the raster line is set as a high-speed printing area and is specified to be printed in the high-speed print mode. When at least part of pixels in one raster line excluding pixels in a background area are identified to be in a specific image area (for example, a photograph), the raster line is set as a standard printing area and is specified to be printed in the standard print mode.

The procedure of the embodiment enables the high-speed printing in the areas including letters and line works, while enabling the high-quality printing with prevention of banding in the areas including photographs. In the case of office or company printing, images including letters and graphs are often printed and photocopied with only black ink. A large portion of such an image is identified to be in a letter/linework area and is subjected to printing in the high-speed print mode. Even mass printing is thus completed within a short time period. The letters and the graphs generally have small printing areas. Printing of such letters and graphs with only black ink in the high-speed print mode desirably makes banding inconspicuous.

### D. Other Aspects

The embodiment and its applications discussed above are to be considered in all aspects as illustrative and not restrictive. There may be many modifications, changes, and alterations without departing from the scope or spirit of the main characteristics of the present invention. Some examples of possible modification are given below.

### D-1 MODIFIED EXAMPLE 1

The labeling process of the above embodiment determines whether each target pixel has the letter/linework attribute, based on Condition 2 ‘luminance of pixel<160 or saturation of pixel<15’. This condition is, however, neither restrictive nor essential. One modified procedure of the labeling process may determine whether each target pixel has the letter/linework attribute and is identified to be in a letter/linework area, based on another condition ‘R, G, and B values of a target pixel are all equal to 0 or all equal to 255’.

### D-2. MODIFIED EXAMPLE 2

The labeling process of the above embodiment uses the data value of each target pixel to identify the attribute of the target pixel among the background attribute, the letter/linework attribute, and the third attribute (for example, photograph) other than the background attribute and the letter/linework attribute. When Windows (registered trademark) is used as the operating system, attribute information representing a letter, a graphic, or a pictorial image is obtainable in the unit of a pixel from the operating system. The obtained attribute information may be used for the attribute identification of each target pixel. The modified attribute identification method enables the highly accurate labeling process to adequately identify each colored letter as a letter/linework area and each monochromatic photograph as a specific image area. This arrangement enables the high-speed printing for colored letters and the high-quality printing with prevention of banding for monochromatic photographs.

### D-3. MODIFIED EXAMPLE 3

The area setting process of the embodiment sets each raster line as one of a print skip area, a high-speed printing area, and a standard printing area and enables separation of these areas only in a sub-scanning direction (that is, in a paper feeding direction). The area setting process is, however, not restricted to this arrangement. One modified procedure of the area setting process may set each pixel as either of a high-speed printing area and a standard printing area and enables separation of these areas in a main scanning direction (in a head scanning direction) as well as in the sub-scanning direction. When at least part of the pixels in the target line is identified to be not in a background area at step S206 in FIG. 3, a modified flow of the area classification process may determine whether each pixel included in the target line is identified to be in a letter/linework area. When the pixel is identified to be in a letter/linework area, the pixel is set as a high-speed printing area. When the pixel is identified to be not in a letter/linework area but in a specific image area, the pixel is set as a standard printing area. When the pixel is identified to be in a background area, the pixel may be set as a high-speed printing area.

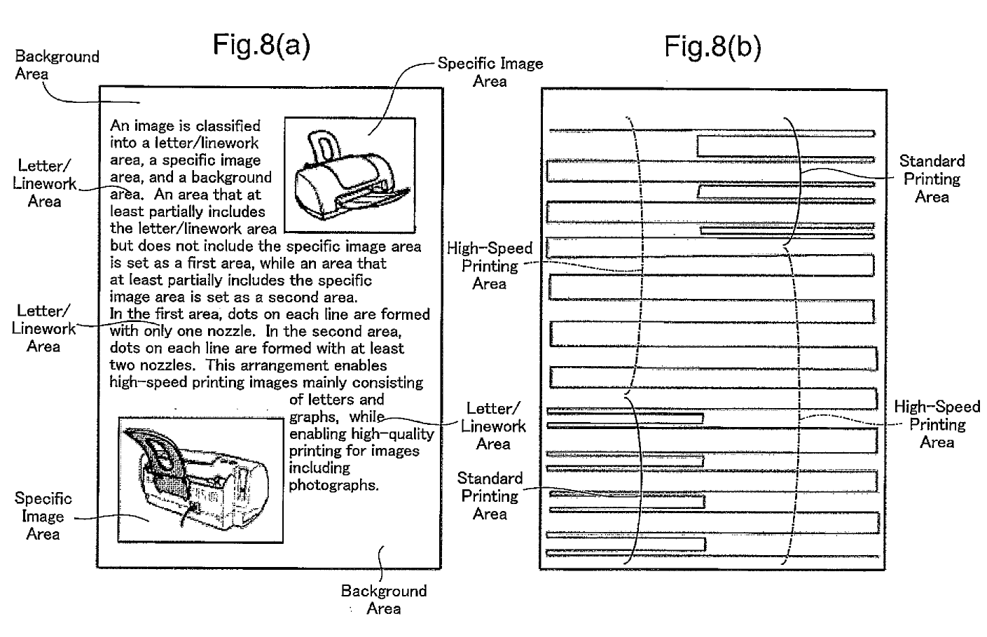

FIG. 8 shows a print object image as a target of printing and a head scan trajectory in printing according to the procedure of Modified Example 3. FIG. 8(a) shows the print object image, which is identical with the print object image of FIG. 4, and FIG. 8(b) shows the head scan trajectory in printing of the print object image according to the procedure of this modified example.

Each letter/linework area in an image is set as a high-speed printing area. In the course of printing the image, the letter/linework area is thus printed at a high speed by one head scan (that is, by one pass). Each specific image area including a photograph in the image is generally set as a standard printing area. In the course of printing the image, the specific image area is printed with high quality by two head scans (that is, by two passes). Changing the reciprocating distance of the head across the boundary between the letter/linework area (high-speed printing area) and the specific image area (standard printing area) enables the higher-speed printing.

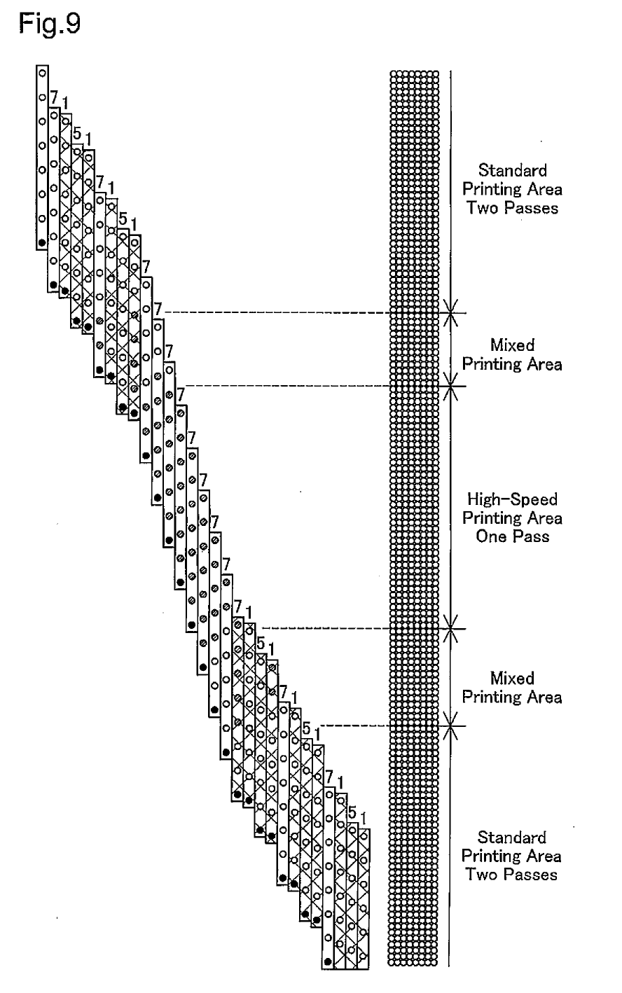

The data mapping to the nozzles and the settings of the paper feed amount in this modified example are explained with reference to a concrete example. FIG. 9 shows a concrete example of data mapping to nozzles and settings of the paper feed amount in Modified Example 3.

In FIG. 9, the cross-hatched nozzle arrays show a range of partially minute reciprocating scans (for example, moving back in the middle of a raster line) in the specific image area (including a photograph).

In the case where specific image areas including photographs are localized in a left half or in a right half of an image, the starting position of the minute reciprocating scans in the image is controlled according to the printing direction in the high-speed print mode, in order to enable optimum printing.

### D-4. MODIFIED EXAMPLE 4

In the embodiment described above, the inkjet printer of the printing device 200 has the head capable of moving back and forth in the preset scanning direction. The technique of the invention is, however, not restricted to the printer of this structure but is also applicable to a line printer configured to have a fixed head with multiple nozzles corresponding to multiple raster lines. Adequate control of the data mapping to the nozzles and the settings of the paper feed amount in this line printer assures the similar effects to those of the embodiment explained previously.

### D-5. MODIFIED EXAMPLE 5

The image processing apparatus 100 is constructed by the personal computer in the above embodiment but may be constructed by another computer, such as a server computer. The printing device 200 includes the printer in the above embodiment but may alternatively include a complex machine or a facsimile device having the printing function. The image processing apparatus 100 may be incorporated in the printing device 200 or in any other image-relating device.

Finally the entire disclosure of Japanese Patent Application No. 2007-204624, filed Aug. 6, 2007 is expressly incorporated by reference herein.

What is claimed is:

1. An image processing apparatus of generating print data to be provided to a printing device from image data representing an image,
the printing device alternately repeating a dot formation process of ejecting a printing liquid from multiple nozzles onto a printing medium to form dots on a line along a preset first direction according to the print data and a feeding process of feeding the printing medium in a preset second direction perpendicular to the first direction,
the printing device arranging multiple dot arrays in the second direction to print an image on the printing medium, where each of the multiple dot arrays consists of multiple dots aligned on a line along the first direction,
the image processing apparatus comprising:
an area classification module configured to classify the image into a background area representing a background, a letter/linework area including letters or linework, and a specific image area other than the background area and the letter/linework area with referring to constituent data of the image data, the area classification module setting an area of the image that at least partially includes the letter/linework area but does not include the specific image area as a first area, while setting an area of the image that at least partially includes the specific image area as a second area, based on a result of the classification; and
a command generation module configured to perform mapping of respective constituent data to the nozzles and setting of a feed amount of the printing medium to form dots on each line along the first direction in the first area with one nozzle and to perform mapping of respective constituent data to the nozzles and setting of the feed amount of the printing medium to form dots on each line along the first direction in the second area with at least two nozzles, the command generation module generating a print command reflecting a result of the mapping of the constituent data to the nozzles and the setting of the feed amount of the printing medium, and outputting data including the generated print command as the print data.

2. The image processing apparatus in accordance with claim 1, wherein the command generation module sets a mixed area on a boundary between the first area and the second area and performs mapping of respective constituent data to the nozzles and setting of the feed amount of the printing medium to allow coexistence of lines of dot formation with one dot and lines of dot formation with at least two nozzles in the mixed area.

3. The image processing apparatus in accordance with claim 1, wherein the area classification module classifies the image in the unit of a line along the first direction and sets each line as the first area on condition that pixels in the line include at least pixels in the letter/linework area but do not include pixels in the specific image area, wile setting each line as the second area on condition that pixels in the line include at least pixels in the specific image area.

4. The image processing apparatus in accordance with claim 1, wherein the area classification module sets the letter/linework area as the first area and the specific image area as the second area.

5. A printing device of ejecting a printing liquid from multiple nozzles onto a printing medium to form dots on lines along a preset direction and thereby print an image,
wherein the image is classified into a background area representing a background, a letter/linework area including letters or linework, and a specific image area other than the background area and the letter/linework area,
in printing a first area of the image that at least partially includes the letter/linework image but does not include the specific image area, the printing device forming dots on each line with one nozzle,
in printing a second area of the image that at least partially includes the specific image area, the printing device forming dots on each line with at least two nozzles.

6. A printing method of ejecting a printing liquid from multiple nozzles onto a printing medium to form dots on lines along a preset direction and thereby print an image,
the printing method comprising:
classifying the image into a background area representing a background, a letter/linework area including letters or linework, and a specific image area other than the background area and the letter/linework area;
in printing a first area of the image that at least partially includes the letter/linework image but does not include the specific image area, forming dots on each line with one nozzle, while in printing a second area of the image that at least partially includes the specific image area, forming dots on each line with at least two nozzles.
